(19) United States
(12) Patent Application Publication
(10) Pub. No.: US 2026/0128980 A1
(43) Pub. Date: May 7, 2026

(54) Delay-based Availability as a TE attribute for Segment Routing

(71) Applicant: Ciena Corporation, Hanover, MD (US)

(72) Inventors: Pankaj Verma, Kanpur (IN); Aditya Mittal, Gurgaon (IN)

(73) Assignee: Ciena Corporation, Hanover, MD (US)

(21) Appl. No.: 18/989,840

(22) Filed: Dec. 20, 2024

(30) Foreign Application Priority Data
Nov. 6, 2024 (IN) 202411085075

(51) Int. Cl. H04L 45/121; H04L 43/0852

(52) U.S. Cl. CPC H04L 45/121; H04L 43/0852

(57) ABSTRACT

Systems and methods for delay-based availability include performing delay measurements with one or more nodes in the Segment Routing network on corresponding links to the one or more nodes; utilizing the delay measurements to determine delay-based availability of the corresponding links to the one or more nodes, wherein the delay-based availability describes how often a given link of the corresponding links is available in terms of quantum time intervals over a measurement interval; and advertising details of the delay-based availability in the Segment Routing network for use as a delay-based availability metric for use as a traffic engineering (TE) metric.

### FIELD OF THE DISCLOSURE

The present disclosure relates generally to networking and computing. More particularly, the present disclosure relates to systems and methods for delay-based availability as a traffic engineering (TE) attribute for Segment Routing, for dynamic path computation, flexible algorithm, etc.

### BACKGROUND OF THE DISCLOSURE

Segment Routing Traffic Engineering (SR-TE) is a network routing paradigm that leverages the principles of Segment Routing (SR) to enable precise path control for traffic flows within an Internet Protocol/Multiprotocol Label Switching (IP/MPLS) network. SR-TE uses a sequence of segments, which are instructions encoded as labels, to direct traffic along a specified path. This approach eliminates the need for complex signaling protocols, such as Resource Reservation Protocol—Traffic Engineering (RSVP-TE), simplifying network operations. With SR-TE, operators can optimize network performance, increase scalability, and achieve more flexible and granular traffic management. By defining specific paths through the network, SR-TE supports advanced applications such as load balancing, latency optimization, and bandwidth reservation, making it particularly suitable for service providers aiming to enhance network efficiency and reliability. One key attribute for SR-TE is availability which is a performance metric that indicates the proportion of time a network (or service/path) is operational, accessible and usable. The conventional approach only considers a forward delay measurement of a link or path.

### BRIEF SUMMARY OF THE DISCLOSURE

The present disclosure relates to systems and methods for delay-based availability as a traffic engineering (TE) attribute for Segment Routing. In SR-TE, availability is a critical performance metric used to assess the reliability of network paths and resources. Availability measures the percentage of time that a network path or service is operational and capable of handling traffic without interruptions. High availability is essential for ensuring continuous network service, especially for applications with strict uptime requirements. SR-TE enables operators to select paths based on availability metrics, allowing for the prioritization of routes that maximize uptime and minimize potential disruptions. By leveraging availability as a metric, SR-TE can dynamically adjust traffic flows to optimize network resilience and ensure that traffic is routed over the most reliable paths. This approach enhances the network's ability to meet service level agreements (SLAs) and provides improved overall user experience by reducing downtime and maintaining consistent service quality.

The present disclosure provides a delay-based availability attribute which combines traditional delay (or latency) key performance indicators (KPIs) with an availability algorithm. This provides a more nuanced view of network performance having specific applicability in scenarios where the network is required to meet specific delay thresholds for a longer duration which is critical to meet SLAs and performance. The advantages of using the delay-based availability over the traditional delay include:
(1) KPIs like packet delay focus solely on delay offering a narrower perspective and do not provide the complete picture of service/path availability.
(2) Availability KPIs are closely aligned with SLAs that define acceptable levels of service/transport uptime/performance.
(3) Availability KPIs provide actual time path/service is accessible/usable with desired performance, directly serving as an important guideline for path selection to enhance available time.

In various embodiments, the present disclosure contemplates implementation as a method with steps, via a node or apparatus with circuitry configured to implement the steps, and as a non-transitory computer-readable medium storing instructions that, when executed, cause circuitry to implement the steps. The steps include performing delay measurements with one or more nodes in a Segment Routing network on corresponding links to the one or more nodes; utilizing the delay measurements to determine delay-based availability of the corresponding links to the one or more nodes, wherein the delay-based availability describes how often a given link of the corresponding links is available in terms of quantum time intervals over a measurement interval; and advertising details of the delay-based availability in the Segment Routing network for use as a delay-based availability metric for use as a traffic engineering (TE) metric.

The steps can further include advertising details of the delay measurements for an average forward delay metric for use as another TE metric along with the delay-based availability metric. The delay-based availability can be determined where the delay measurements are used to compare to a delay threshold for each quantum time interval to determine an available indicator and an unavailable indicator. The delay-based availability metric for a given measurement interval can be based on [Available Indicator/(Available Indicator+Unavailable Indicator)]. The delay-based availability can be determined utilizing a loss-based availability algorithm defined in Metro Ethernet Forum (MEF) 10.3/35.1 where the delay measurements are used to compare to a delay threshold for each quantum time interval. The delay measurements can utilize one of Two-Way Active Measurement Protocol (TWAMP) sessions and Simple Two-Way Active Measurement Protocol (STAMP).

The details of the delay-based availability can be advertised in a delay-based availability sub-Type-Length-Value (TLV). The details of the delay-based availability can be advertised in a Flexible Algorithm Definition sub-Type-Length-Value (TLV). The steps can further include receiving advertisements of details of the delay-based availability for other links from other nodes in the Segment Routing network; and utilizing the delay-based availability for links in the Segment Routing network for TE path computation. The TE path computation can select a path in the Segment Routing network based on the delay-based availability and based on average forward delay metric, such that a path having highest delay-based availability is selected.

### BRIEF DESCRIPTION OF THE DRAWINGS

The present disclosure is detailed through various drawings, where like components or steps are indicated by identical reference numbers for clarity and consistency.

FIG. 1 illustrates a network including a plurality of nodes interconnected by links for describing the delay-based availability.

FIG. 2 illustrates a segment in the network between the nodes for illustrating issues with using average forward delay as a TE metric for SR-TE path computation.

FIG. 3 illustrates an example delay-based availability calculation.

FIG. 4 illustrates a flowchart of a process of computation of delay-based availability using TWAMP test packets.

FIG. 5 illustrates a new ISIS availability sub-TLV for advertising the availability KPIs in IGP.

FIG. 6 illustrates Unidirectional delay-based availability in an ISIS Flexible Algorithm Definition sub-TLV.

FIG. 7 illustrates a flowchart of a process for determining and advertising delay-based availability as a traffic engineering (TE) attribute for Segment Routing.

### DETAILED DESCRIPTION OF THE DISCLOSURE

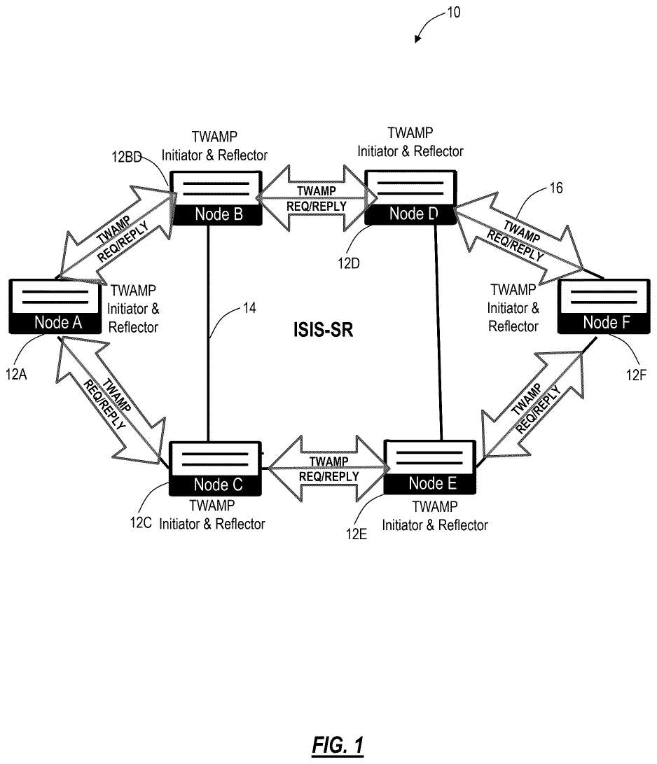

Again, the present disclosure relates to systems and methods for delay-based availability as a traffic engineering (TE) attribute for Segment Routing. FIG. 1 illustrates a network 10 including a plurality of nodes 12A-12F interconnected by links 14 for describing the delay-based availability. The network 10 is a Segment Routing network utilizing Intermediate System to Intermediate System Segment Routing (ISIS-SR). ISIS-SR is a network protocol extension that enables the deployment of Segment Routing within an IP/MPLS network by leveraging the ISIS routing protocol. ISIS-SR allows routers to advertise segment identifiers (SIDs), which represent specific network paths or resources, through the ISIS protocol. This integration enables the creation of SR-based forwarding paths without relying on additional signaling protocols. By utilizing ISIS-SR, network operators can implement efficient and scalable traffic engineering with minimal configuration. ISIS-SR supports flexible path selection, reduces protocol overhead, and facilitates optimized resource utilization, making it ideal for modern networks requiring simplified management and enhanced performance.

The nodes 12A-12F (also referred to as network elements), typically a router or switch, direct traffic along specified paths through the network 10. These nodes 12A-12F are equipped with hardware components such as forwarding engines, processors, and memory units that enable the handling of SIDs and the execution of SR instructions. Functionally, an SR node forwards packets based on the SID stack embedded within the packet header, guiding traffic through designated waypoints or directly to its destination. The node interprets each SID as a command to either forward, swap, or pop labels from the stack, thus facilitating traffic steering and policy enforcement. Advanced SR nodes may also include specialized hardware like ASICs (Application-Specific Integrated Circuits) to accelerate label processing, enhance throughput, and support high-performance traffic engineering.

Two-Way Active Measurement Protocol (TWAMP) test sessions are commonly used in SR-TE to measure and monitor network performance in real-time. TWAMP is a protocol designed to actively measure metrics like latency, jitter, and packet loss between two nodes 12A-12F in the network 10. These TWAMP measurements provide valuable insights into the actual state of the network 10, which can be used to make informed traffic engineering decisions. By continuously monitoring SR-TE paths, operators can dynamically adjust routing to avoid congested or underperforming paths, ensuring that traffic is always directed along the most optimal routes. This enhances the reliability and efficiency of the network, helps maintain service level agreements (SLAs), and improves overall user experience. Furthermore, the integration of TWAMP with SR-TE allows for proactive network management, enabling quick identification and resolution of issues before they impact critical services.

While the present disclosure uses TWAMP, it is also possible to use STAMP. Simple Two-Way Active Measurement Protocol (STAMP) is a lightweight protocol designed for active performance monitoring of network paths. Like TWAMP, STAMP measures metrics such as delay, jitter, and packet loss between two network nodes. However, STAMP simplifies the process by eliminating some of the complexities associated with TWAMP, making it easier to implement and less resource-intensive.

In FIG. 1, there are TWAMP test sessions 16 configured on each of the nodes 12A-12F to compute delay in a forward direction, e.g., between the nodes 12A→12B, 12B→12A, 12A→12C, 12C→12A, and so on. In SR-TE, computed forward delay KPIs for each link 14 are communicated to the SR control plane through the ISIS protocol. Specifically, these delay metrics are advertised using the ISIS TE extensions, which include the uni-directional delay metric Type-Length-Value (TLV) format. The uni-directional delay metric TLV encapsulates the measured delay for a link 14 in one direction, providing a precise indicator of the time required for traffic to traverse that link. By advertising these metrics through ISIS, each node 12A-12F in the network 10 can update its SR control plane with real-time delay information. The SR control plane then uses this data to compute optimal paths for traffic flows, considering delay as a critical factor. This process allows the SR-TE network 10 to dynamically adjust routing based on current network conditions, ensuring that traffic is directed through paths that meet specified delay requirements. This capability is particularly valuable for delay-sensitive applications, as it helps to maintain low latency and high performance by continuously monitoring and responding to link-specific delay characteristics. For example, the node 12A can compute a SR-TE path with the lowest average forward delay to the node 12F.

The SR control plane is the component within the network 10 responsible for managing and distributing routing information. It determines the path that data packets should take based on SIDs, which define specific instructions or waypoints along the route. The SR control plane uses protocols like the Interior Gateway Protocol (IGP)—such as ISIS—to advertise and disseminate information about available network segments, including links, nodes, and associated metrics like delay or bandwidth. In an SR-TE environment, the SR control plane plays a crucial role in dynamically computing optimal paths based on real-time network conditions and performance metrics. By leveraging the SR control plane, network operators can control traffic flows with precision, optimize resource utilization, and maintain high levels of performance and reliability. The control plane's decisions are then enforced by the data plane, which forwards packets according to the instructions embedded in the SID stack, allowing for efficient and scalable traffic management.

Conventionally, the SR-TE performance monitoring framework focuses solely on measuring the forward delay of links or paths. IP link delay is calculated using TWAMP packets, and these delay measurements are published to the Interior Gateway Protocol (IGP). Each node 12A-12F then advertises this delay information through the traffic-engineering sub-TLV of the IGP. This allows the Path Computation Element Protocol (PCEP) or a centralized controller to compute SR-TE paths based on optimal delay metrics. Additionally, the controller or user can define flexible algorithms (Flex-Algo) that use delay as a TE metric.

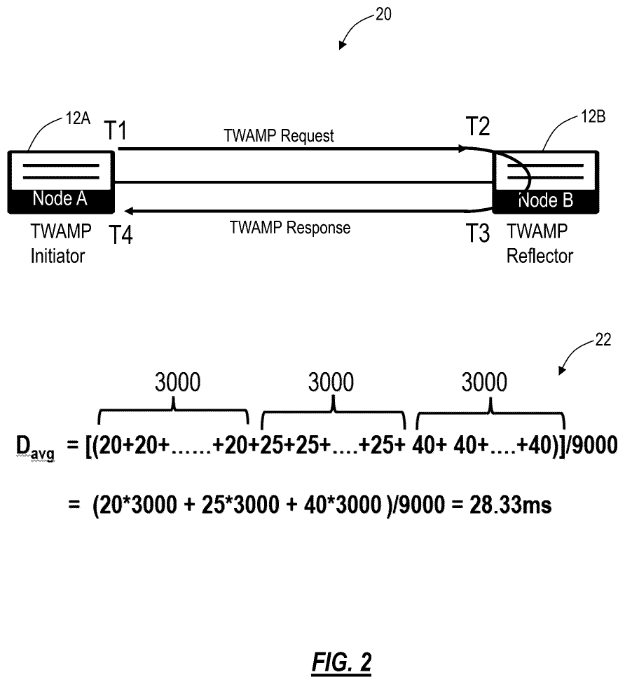

FIG. 2 illustrates a segment 20 in the network 10 between the nodes 12A, 12B for illustrating issues with using average forward delay as a TE metric for SR-TE path computation. TWAMP assesses network performance by exchanging timestamped test packets between the two nodes 12A, 12B: the initiator (node 12A) and the responder (node 12S). The process begins with the initiator requesting a TWAMP session with the responder. Once the session is established, the initiator sends a test packet to the responder with an embedded timestamp (T1) marking the time of transmission. Upon receiving the packet, the responder immediately records the time (T2) and then sends the packet back to the initiator with an additional timestamp (T3) indicating the time it was forwarded back. When the initiator receives the returned packet, it logs the final timestamp (T4), the time at which the packet was received back.

Again, the conventional approach using delay as a SR-TE attribute is to use the forward delay. The forward delay can be estimated by analyzing the time difference between T1 and T2, namely T2 minus T1. For illustrating how the forward delay can be problematic, consider a TWAMP test with the following values:

| | |
|---|---|
| Iteration Duration | 15 min = 900 s |
| Message Interval | 100 ms |
| Total Packet Per Iteration Duration | 900 × 10 = 9000 |
| Delay Threshold | 30 ms |

Based on above configuration, there will be 9000 delay values in dataset, i.e., {D₁, D₂, . . . , D₉₀₀₀}. Here, D₁ is forward direction delay computed by the first TWAMP request/reply transaction and D₉₀₀₀ is the TWD computed by the last request/reply transaction in each iteration duration. At the end of iteration duration, the average delay will be computed as:

$$Average Forward Delay ( {D}_{avg} ) = ( {D}_{1} + {D}_{2} + … + {D}_{9000 )} / 9000$$

Here, each computed delay, i.e., Dᵢ (for i=1 to 9000) is not contributing to performance evaluation with respect to the configured delay threshold. Rather, the average delay is used for evaluation which may not give accurate results. Consider an example forward delay dataset of: {D₁=−20 ms, . . . , D₃₀₀₀=−20 ms, D₃₀₀₁=−25 ms, . . . , D₆₀₀₀=−25 ms, D₆₀₀₁=−40 ms, . . . , D₉₀₀₀=−40 ms}, i.e., the first 3000 data points are −20 ms, the second 3000 data points are ˜25 ms, and the final 3000 data points are −40 ms. The compute average forward delay is shown in calculation 22 in FIG. 2. Although, the computed average forward delay, 28.33 ms, in this iteration duration is less than the configured delay threshold of 30 ms, there is a period (300 s), i.e., from D₆₀₀₀ to D₉₀₀₀ where the delay exceeded configured threshold value. That is, the average forward delay is 28.33 ms but the computed forward delay was above the desired delay threshold for 5 mins out of 15 mins. This period is never accounted for because the average forward delay is less than the configured delay threshold.

Ideally, these values should exclude this link because the delay threshold is this example is not really met. Currently, there is no mechanism to compute delay-based availability. Also, there is no mechanism to propagate the delay-based availability as a KPI to IGP, allowing a PCEP/Controller to consider the delay-based availability as a TE metric. Rather, delay-based availability can provide a much more granular view of entire during resulting in better path selection. As described herein, delay-based availability is a computed metric or KPI which combines delay such as from TWAMP and availability from an availability algorithm.

An example availability algorithm is described in Metro Ethernet Forum (MEF) 10.3/35.1. These are described in MEF 10.3 Carrier Ethernet Services Attributes Phase 3, Metro Ethernet Forum, April 2013, and MEF 35.1 Service OAM Performance Monitoring Implementation Agreement Phase 2, Metro Ethernet Forum, August 2014, the contents of each are incorporated by reference in their entirety. MEF 10.3 defines the service attributes and parameters for Carrier Ethernet services, including key performance indicators like frame loss, delay, and availability. MEF 35.1 provides guidelines for implementing performance monitoring in Carrier Ethernet networks, including frame loss and availability measurement methodologies in compliance with ITU-T standards like Y.1731, which is in ITU-T Recommendation Y.1731: OAM Functions and Mechanisms for Ethernet Based Networks, International Telecommunication Union, February 2019, the contents of which are incorporated by reference in their entirety. Y.1731 outlines Operations, Administration, and Maintenance (OAM) functions, including performance monitoring metrics such as frame delay, frame delay variation, and frame loss, used for managing Ethernet-based networks. Those skilled in the art will recognize other availability algorithms are also contemplated.

The MEF 10.3/35.1 algorithm calculates network availability as a KPI by analyzing frame loss using ITU-T Y.1731 Synthetic Loss Measurement (SLM) and Synthetic Loss Reply (SLR) frames. This process involves sending SLM frames from a source to a destination over a specified interval, where the frames are then counted to determine how many were successfully received versus lost. The destination node replies with SLR frames, which confirm the number of frames received. Based on the frame loss ratio, which is calculated by comparing sent and received frames, the algorithm can determine the link's availability over the monitored period. Availability is then expressed as the percentage of time during which the frame loss remains below a predefined threshold, indicating the network is performing adequately. By continuously measuring and analyzing frame loss with this method, operators can ensure the network meets required service level agreements (SLAs) and maintain high levels of service reliability.

Note, the traditional output of the MEF 10.3/35.1 algorithm is “loss-based availability,” namely a percentage which indicates how much a link is available over the measurement interval based on loss threshold. The present disclosure contemplates using this approach except with delay instead of loss. As such, the present disclosure defines a delay-based availability KPI which provides a better approach over traditional delay KPIs as a TE metric for dynamic path computation and flex-algo allowing controller/PCEP to compute an SR-TE path having better availability (with respect to delay). This solution proposes the application of an existing loss-based availability algorithm, as defined in the MEF 10.3/35.1 standard, instead using delay to compute delay-based availability using TWAMP or STAMP sessions. No changes are needed for delay KPIs computed through TWAMP/STAMP sessions, allowing both delay and availability KPIs to coexist. Availability metrics computed over network links 14 are shared with IGP to facilitate traffic-engineered IP/MPLS path computation. Additionally, availability can be computed over end-to-end IP/MPLS paths to meet SLAs.

To calculate availability, parameters such as the deltaT interval and the availability measurement interval must be specified within the TWAMP/STAMP test sessions. A new sub-TLV for delay-based availability is proposed, and similar TLVs could be defined for other IGP protocols. Furthermore, a new metric type, “unidirectional delay-based availability,” has been defined for use in Flex-Algo definitions. The delay-based availability KPI can be leveraged by traffic engineering protocols such as Segment Routing with MPLS data plane (SR-MPLS), Segment Routing over IPv6 (SRv6), Segment Routing Traffic Engineering (SR-TE), and Resource Reservation Protocol with Traffic Engineering (RSVP-TE). While this focuses on computing availability using existing TWAMP/STAMP delay values, the proposed solution can also be extended to calculate loss-based availability using TWAMP/STAMP packets, utilizing sequence numbers for accuracy.

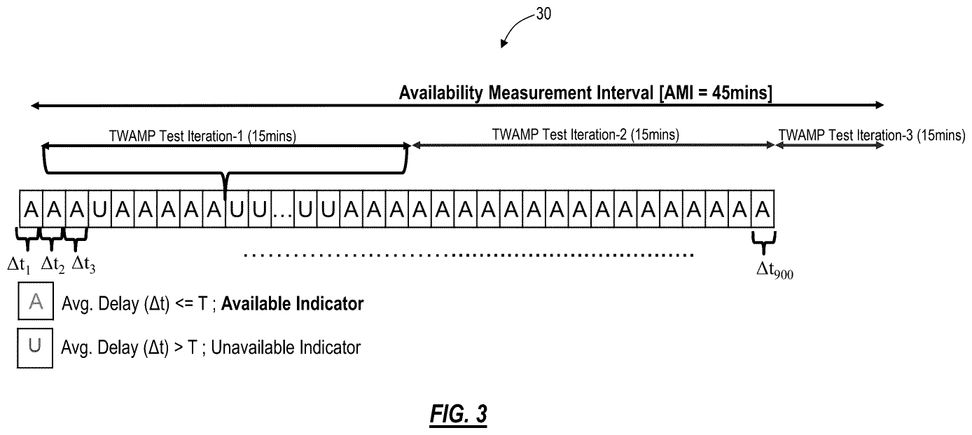

FIG. 3 illustrates an example delay-based availability calculation 30. Again, the MEF 10.3 and 35.1 standards outlines the algorithm and configuration parameters to compute the loss-availability KPI using ITU-T Y.1731 Synthetic loss frames measured over a period called an availability measurement interval (AMI). The present disclosure contemplates computing delay-based-availability using TWAMP/STAMP test packets along with delay-based KPIs. The AMI is configured such that it is integral multiple of the Iteration Duration.

The delay-based availability calculation 30 is shown in the example in FIG. 3 where each AMI (45 mins) encompasses 3 TWAMP test iterations each having a duration of 15 mins. The following are used in the calculation:

| | |
|---|---|
| Δt (also written herein as | Quantum time interval within a given test |
| DeltaT) | iteration over which average delay is |
| | evaluated |
| Min Δt value | Message Interval |
| Max Δt Value | Iteration Duration |
| T | Configured Delay Threshold |

For example, based on the previous example in FIG. 2, the Δt duration can be configured within a range 100 ms (1 message interval) to 15 mins (iteration duration). Assume the Message Interval is configured as 100 ms and the Δt interval as 1 s. So, there will be 10 TWAMP requests within each Δt. There will be 900 such Δt's within the test iteration duration, i.e., 15 mins and 2700 (900*3) such Δt's within AMI i.e., 45 mins. At the end of each Δt, the average delay is computed (instead of at end of the test iteration duration) and based on results it will be compared against the configured delay threshold to mark this as available or unavailable. On completion of the AMI, availability KPIs will be published.

Specifically, DeltaT defines a discrete or quantum time interval over the entire measurement interval (AMI). The delay-based availability represents how many discrete or quantum time intervals are marked available in the measurement interval. This is a better view of delay versus taking all of the delay measurements of the measurement interval and averaging them.

Specifically, averaging measurements over an interval with wide variation in values may not accurately reflect actual performance, as it can mask significant fluctuations. When values vary widely, an average can obscure spikes or dips, which are crucial for understanding real-time network conditions, particularly for metrics like delay that are highly sensitive to fluctuations. For instance, latency-sensitive applications may suffer during periods of high delay, even if the average delay over time seems acceptable. This is because the average fails to reveal moments of extreme delay that could disrupt services such as Voice over IP (VoIP) or video conferencing. High variability in measurements often signals instability or congestion, which an average can obscure, leading to an inaccurate assessment of network reliability and potentially resulting in suboptimal routing decisions. Additionally, outliers can skew the average, either inflating it due to occasional high values or underestimating issues due to intermittent low values. For these reasons, relying solely on averages can be misleading in variable environments, and it is often more informative to consider other statistical measures, such as standard deviation, percentiles, or maximum values, to provide a fuller picture of performance across the interval.

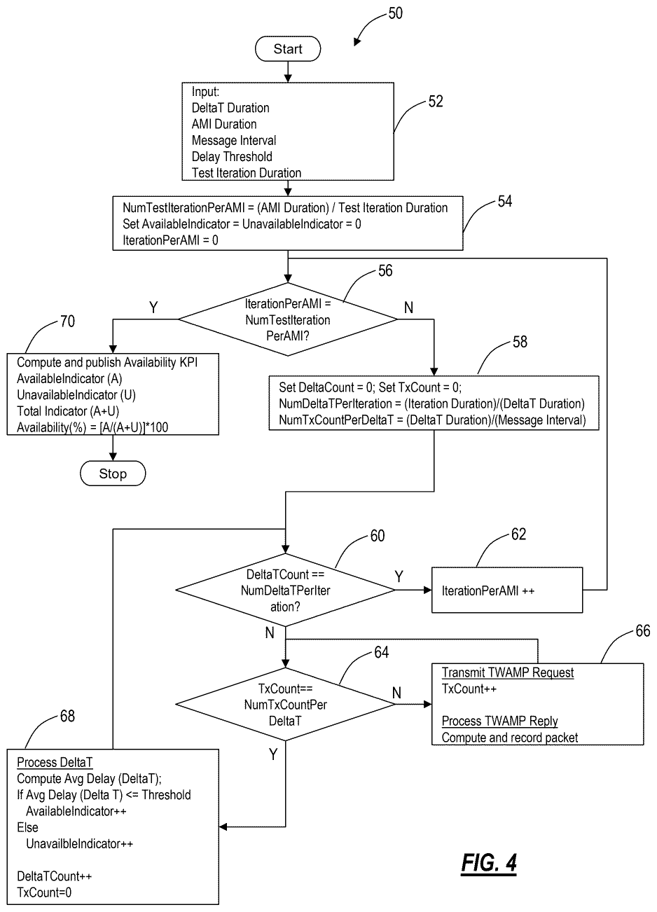

FIG. 4 illustrates a flowchart of a process 50 of computation of delay-based availability using TWAMP test packets. The process 50 contemplates implementation as a method having steps, via an apparatus with one or more processors configured to implement the steps, and as a non-transitory computer-readable medium storing instructions that, when executed, cause one or more processors to implement the steps.

The process 50 starts and inputs are received, configured, or determined (steps 52, 54). Using the previous examples described above, the following variables are used in this Reference Example for the input:

Reference Example

| | |
|---|---|
| DeltaT Duration | 1 s |
| AMI Duration | 30 mins = 1800 s |
| Message Interval | 100 ms |
| Test Iteration Duration | 15 mins = 900 s |
| Delay Threshold | 30 ms |
| NumTestIterationPerAMI | 1800 s/900 s = 2 |
| NumDeltaTPerIteration | 900 s/1 s = 900 |
| NuxTxCountPerDeltaT | 1 s/100 ms = 100 |

The testing begins with a loop counter where an IterationPerAMI index is initially set to 0, and the loop will continue until IterationPerAMI equal the NumTestlterationPerAMI (step 56). When IterationPerAMI does not equal NumTestlterationPerAMI (step 56), the process 50 includes performing measurements which includes setting the DeltaCount to 0, the TxCount to 0, the NumDeltaTPerlteration to (Iteration Duration)/(DeltaT Duration), the NumTxCountPerDeltaT to (DeltaT Duration)/(Message Interval) (step 58). At this point, a DeltaTCount used to continue until it equals the NumDeltaTPerlteration (step 60), and when it does, the IterationPerAMI is incremented (step 62) and the process 50 goes to step 56. When the DeltaTCount equals the NumDeltaTPerlteration (step 60). The process 50 checks whether the TxCount equals the NumTxCountPerDeltaT (step 64), and, if not, a TWAMP request is transmitted, TxCount is incremented, and the TWAMP reply is computed and recorded (step 66).

When the TxCount equals the NumTxCountPerDeltaT (step 64), the DeltaT is processed by computing the average delay in the DeltaT, if the average delay is less than or equal to the delay threshold, an Availablelndicator (A) is incremented, otherwise an Unavailblelndicator (U) is incremented, the DeltaTCount in incremented, and the TxCount is reset to 0 (step 68). The process 50 returns to the step 60 after the step 68.

If the IterationPerAMI equals the NumTestlterationPerAMI (step 56), then the delay availability KPI is computed and published (step 70). This utilizes the AvailableIndicator (A) and the Unavailblelndicator (U), and a Totallndicator (A+U). The Availability is a percentage and equals [A/(A+U)]*100.

This value provides a KPI of availability over the Test Iteration Duration as a percentage value where the percentage indicates the amount of time in the Test Iteration Duration that the link meets the Delay Threshold. Delay, on the other hand, provides an average amount of delay over the Delay Threshold. The combination of these two values can be used for delay-based availability. That is, the present disclosure adds a new availability KPI which can be used along with the delay KPI.

The following provides two example calculations—one between the nodes 12A→12B and one between the nodes 12A→12C. There is a proactive TWAMP test configured on these links with the following values (same as above):

| | |
|---|---|
| Availability Measurement Interval | 15 min = 900 s |
| (AMI) = Iteration Duration | |
| Message Interval | 100 ms |
| Total Packet Per Iteration | 900 * 10 = 9000 |
| Δt duration | 1 s (i.e., 10 packets in each Δt) |
| Delay Threshold | 30 ms |

First, delay versus availability is described for the link between the nodes 12A→12B. Assume the following average forward delay for each Δt's

$$\{ Δ {t}_{1} = ∼ 20 ms , … , Δ {t}_{300} = ∼ 20 ms , Δ {t}_{301} = ∼ 25 ms , … ,$$

$$Δ {t}_{600} = ∼ 25 ms , Δ {t}_{601} = ∼ 40 ms , … , Δ {t}_{900} = ∼ 40 ms \}$$

In summary, the above dataset can be simplified as follows:
(1) Forward delay computed for each Δt₁ to Δt₃₀₀ has value ˜20 ms
(2) Forward delay computed for each Δt₃₀₁ to Δt₆₀₀ has value ˜25 ms
(3) Forward delay computed for each Δt₆₀₀ to Δt₉₀₀ has value ˜40 ms

As computed in FIG. 2, the average forward delay=28.33 ms, which is below the Delay Threshold when just looking at the delay KPI.

The availability KPI within an AMI will be as follow:

$$Number of available indicator = 600 [ From Δ {t}_{1} to Δ {t}_{600} ] \qquad ( 1 )$$

$$Number of unavailable indicator = 300 [ From Δ {t}_{600} to Δ {t}_{900} ] \qquad ( 2 )$$

$$The forward availability \% = [ Available Indicator ] \text{} / [ Total Indicators ] * 100 = [ ( 600 ) / ( 600 + 300 ) ] * 100 = 66.67 \%$$

Although, the computed average delay, i.e., 28.3 ms (i.e., within configured threshold) but availability of link is 66.67% indicating the link delay is less than configured threshold for 66.67% of total measurement duration.

Second, delay versus availability is described for the link between the nodes 12A+12C. Assume the following average forward delay for each Δt's

$$\{ Δ {t}_{1} = ∼ 28 ms , … , Δ {t}_{850} = ∼ 28 ms ,$$

$$Δ {t}_{851} = ∼ 90 ms , … , Δ {t}_{900} = ∼ 90 ms \}$$

In summary, above dataset can be simplified as follows:
(1) Forward delay computed for each Δt₁ to Δt₈₅₀ has value ˜28 ms
(2) Forward delay computed for each Δt₈₅₁ to Δt₉₀₀ has value ˜90 ms

The average forward delay=(28+28+ . . . +28+90+90 . . . +90)/9000=(28*8500+90*500)/9000=31.5 ms, which is above the delay threshold when looking solely at this KPI.

Note, each Δt includes 10 packets, and the availability KPI within an AMI will be as follow:

$$Number of available indicator = 850 [ From Δ {t}_{1} to Δ {t}_{850} ] \qquad ( 1 )$$

$$Number of unavailable indicator = 50 [ From Δ {t}_{851} to Δ {t}_{900} ] \qquad ( 2 )$$

$$The forward availability \% = [ Available Indicator ] \text{} / [ Total Indicators ] * 100 = [ ( 850 ) / ( 850 + 50 ) ] * 100 = 94.47 \%$$

Although, the computed average delay, i.e., 31.5 ms is above configured delay threshold but this link has significantly higher availability indicating that link delay is less than configured threshold for 94.47% of total measurement duration. Advantageously, with proposed solution, the controller/PCEP has option to compute a highly available path, i.e., via the link between the nodes 12A→12C, based on type of services to meet the SLA requirement.

Those skilled in the art will understand the above examples and values are presented for illustrative purposes. The intent of these example datasets is to depict the how skewness in delay values computed over iteration duration can result in selection of sub-optimal path but using availability KPIs we can mitigate the same.

The foregoing describes approaches to computing the availability KPI which can be used for delay-based availability decisions. Also, there is a need to advertise this information by the nodes 12A-12F. The following describes some example approaches, and those skilled in the art will recognize other approaches are also contemplated.

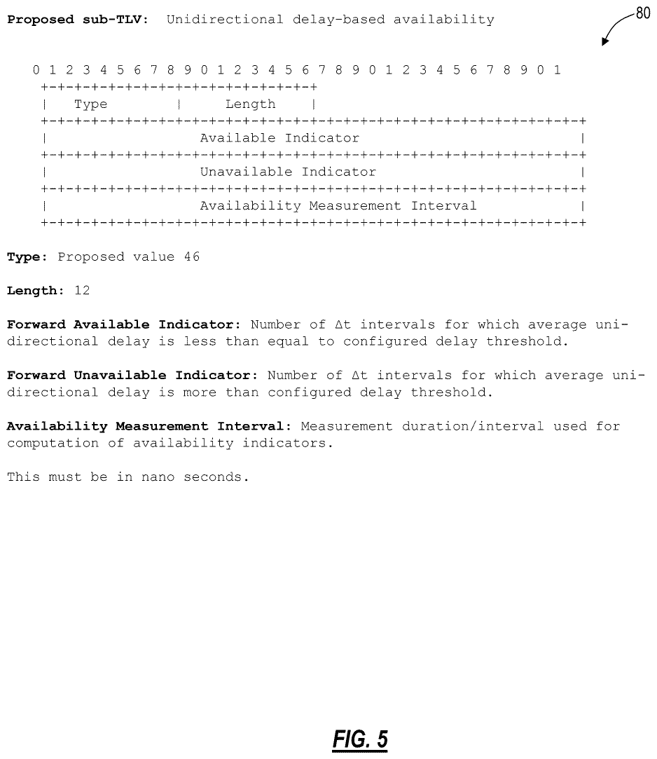

FIG. 5 illustrates a new ISIS availability sub-TLV 80 for advertising the availability KPIs in IGP. The sub-TLV 80 is a data structure used within ISIS packets to communicate specific network attributes and metrics. Sub-TLVs are typically embedded within the larger ISIS TLV structures, which are then transmitted as part of ISIS Link State Protocol Data Units (LSPs). These LSPs carry various types of information necessary for routing and traffic engineering within an Interior Gateway Protocol (IGP) network. ISIS sub-TLVs can convey details like link metrics, delay, bandwidth, and availability. By including these metrics, each node 12A-12F in the network 10 can make informed routing decisions based on real-time network conditions. For example, delay-based availability metrics described herein encapsulated in the sub-TLV 80 can be used by the control plane to compute optimized paths for SR-TE, ensuring that traffic is routed along the most efficient and reliable routes. Sub-TLVs thus enhance the functionality of ISIS by enabling more granular and specific data exchange, critical for advanced network operations like SR, Flex-Algo, and other TE applications.

In an embodiment, the ISIS availability sub-TLV 80 can be defined, e.g., with a value 46, as “Uni-directional delay-based availability.” This Sub-TLV 80 advertises the availability metrics computed between two directly connected neighbors. The metric advertised by this TLV is the delay-based-availability of link from the local node to the peer node. When these metrics are received in the ISIS protocol, it can compute the availability using following formula and can be fed to SR for dynamic path computations and Flex algorithm definitions.

$$Availability = [ \text{} Available Indicator \% ( Available Indicator + Unavailable Indicator ) ] * 100 \%$$

Some example attributes of the sub-TLV 80 can include:

| | |
|---|---|
| Type | Proposed value 46 |
| Length | 12 |
| Forward Available Indicator | Number of Δt intervals for which average |
| | uni-directional delay is less than equal to |
| | configured delay threshold |
| Forward Unavailable | Number of Δt intervals for which average |
| Indicator | uni-directional delay is more than |
| | configured delay threshold |
| Availability Measurement | Measurement duration/interval used for |
| Interval | computation of availability indicators. |
| | This must be in nano seconds. |

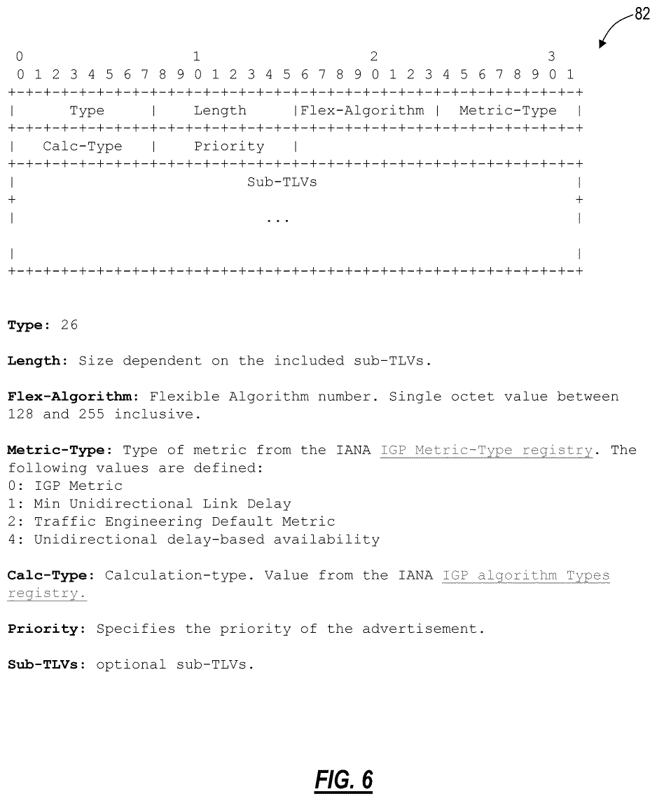

FIG. 6 illustrates Unidirectional delay-based availability in an ISIS Flexible Algorithm Definition sub-TLV 82. The ISIS Flexible Algorithm Definition sub-TLV 82 is a data structure used to specify the parameters for Flexible Algorithms (Flex-Algo) within an ISIS-enabled network. This sub-TLV is embedded within ISIS packets, specifically in ISIS Link State Protocol Data Units (LSPs), and it contains details about the algorithm's attributes and constraints, such as metric types, affinities, and optimization criteria. The Flex-Algo sub-TLV 82 allows network operators to define custom routing algorithms that suit specific traffic engineering requirements, such as paths optimized for latency, bandwidth, or availability. By advertising this information, each network node gains an understanding of the Flex-Algo configurations in use, enabling them to route traffic according to these custom policies.

The following metric types are defined for the Flex-Algo sub-TLV 82

| | |
|---|---|
| 0 | IGP Metric |
| 1 | Min Unidirectional Link Delay |
| 2 | Traffic Engineering Default Metric |

The present disclosure contemplates a new metric type, e.g., “4” for Unidirectional delay-based availability. This Flex-Algo sub-TLV 82 is used to advertise the definition of the Flex-Algorithm.

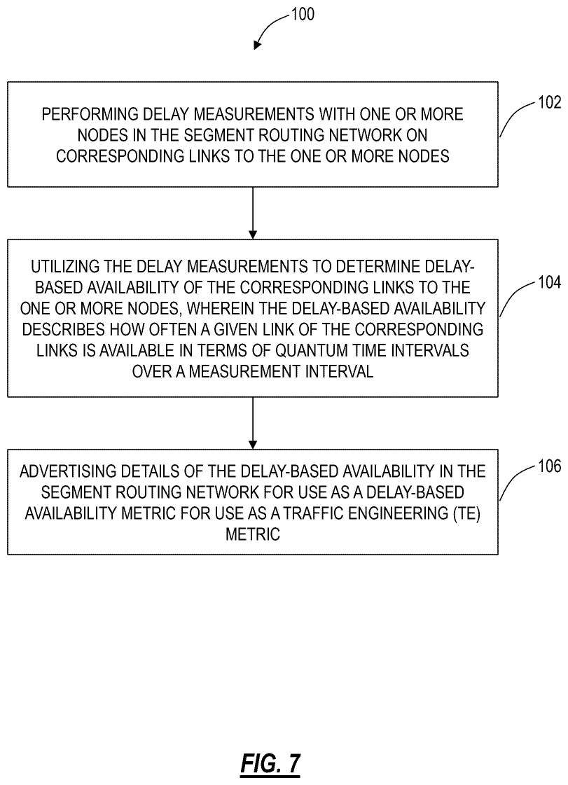

FIG. 7 illustrates a flowchart of a process 100 for determining and advertising delay-based availability as a traffic engineering (TE) attribute for Segment Routing. The process 100 contemplates implementation as a method having steps, via an apparatus with one or more processors configured to implement the steps, and as a non-transitory computer-readable medium storing instructions that, when executed, cause one or more processors to implement the steps. The apparatus, method, and non-transitory computer-readable medium are associated with a network element such as one of the nodes 12A-12F.

The steps include performing delay measurements with one or more nodes in the Segment Routing network on corresponding links to the one or more nodes (step 102); utilizing the delay measurements to determine delay-based availability of the corresponding links to the one or more nodes, wherein the delay-based availability describes how often a given link of the corresponding links is available in terms of quantum time intervals over a measurement interval (step 104); and advertising details of the delay-based availability in the Segment Routing network for use as a delay-based availability metric for use as a traffic engineering (TE) metric (step 106). The steps can further include advertising details of the delay measurements for an average forward delay metric for use as another TE metric in addition to the delay-based availability metric. That is, the delay-based availability metric is a separate metric from the average forward delay metric.

The delay-based availability is determined where the delay measurements are used to compare to a delay threshold for each quantum time interval to determine an available indicator and an unavailable indicator. The delay-based availability metric for a given measurement interval can be determined as [Available Indicator/(Available Indicator+Unavailable Indicator)]*100. The delay-based availability can be determined utilizing a loss-based availability algorithm defined in Metro Ethernet Forum (MEF) 10.3/35.1 where the delay measurements are used to compare to a delay threshold for each quantum time interval. The delay measurements can utilize one of Two-Way Active Measurement Protocol (TWAMP) sessions and Simple Two-Way Active Measurement Protocol (STAMP). The details of the delay-based availability can be advertised in a delay-based availability sub-Type-Length-Value (TLV). The details of the delay-based availability can be advertised in a Flexible Algorithm Definition sub-Type-Length-Value (TLV).

The steps can further include receiving advertisements of details of the delay-based availability for other links from other nodes in the Segment Routing network; and utilizing the delay-based availability for links in the Segment Routing network for TE path computation. In an embodiment, the TE path computation selects a path in the Segment Routing network based on the delay-based availability and based on average forward delay metric, such that a path having the average forward delay metric greater than a delay threshold is selected based on the delay-based availability.

The proposed solution applies an existing loss-based availability algorithm, as defined in the MEF 10.3/35.1 standard, to calculate delay-based availability using TWAMP or STAMP sessions. This method maintains compatibility with existing delay KPIs from TWAMP/STAMP sessions, allowing both delay and availability KPIs to coexist. The computed link availability metrics are shared with the IGP, enabling traffic-engineered path computations for IP/MPLS networks. Additionally, availability can be calculated over end-to-end IP/MPLS paths to meet SLAs.

To compute availability, the solution requires specifying the deltaT interval and the availability measurement interval within the TWAMP/STAMP test session configurations. A new sub-TLV is proposed for delay-based availability, and similar TLVs could be developed for other IGP protocols, like OSPF and BGP. The present disclosure introduces a new metric type, “unidirectional delay-based availability,” for use in Flex-Algo. This delay-based availability KPI can support various TE protocols, including SR-MPLS, SRv6, SR-TE, and RSVP-TE.

In addition, the present disclosure extends the solution to compute availability using loss-based metrics through TWAMP/STAMP packets by leveraging sequence numbers. Novel proposals include introducing a new ISIS sub-TLV type value (46) for delay-based availability propagation and defining a new metric type value (4) for unidirectional delay-based availability in the ISIS Flexible Algorithm Definition sub-TLV. Lastly, new configuration parameters, such as deltaT interval and availability measurement interval, have been proposed for TWAMP/STAMP test sessions.

Note, the terms attribute, metric, and KPI are all used here interchangeably, namely as some value that is used in path computation. The delay-based availability metric is one that determines how available a link is over a measurement interval (e.g., AMI) in terms of delay relative to a delay threshold. Also, a delay metric is one that indicates the average forward delay during the measurement interval. Again, while these metrics describe similar aspects of the link, the delay-based availability metric is more nuanced providing a better view of the link relative to a simple average of delay over the measurement interval.

The proposed solution enhances user experience and ensures compliance with SLAs, particularly for delay-sensitive applications such as video streaming and real-time voice services. Even brief periods of high delay can severely impact these applications. By implementing a delay-based availability constraint, such as 99.999%, the solution helps to maintain a more reliable experience. Unlike the average delay metric, which does not indicate when a delay threshold has been breached, delay-based availability provides a more actionable dataset by quantifying instances when the delay exceeds acceptable limits.

This approach allows network operators to provision paths with higher availability, optimizing service delivery. By enabling performance monitoring at smaller intervals over longer durations, the solution provides richer data points, which can be used to further enhance network performance. Additionally, the delay-based availability metric can be applied to emerging technologies like Segment Routing with MPLS data plane (SR-MPLS), Segment Routing over IPv6 (SRv6) Dynamic Path, and Flexible Algorithms (Flex-Algo) computations.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner-whether collectively, in subsets, or individually-thereby broadening the range of potential embodiments.

What is claimed is:

1. A node in a Segment Routing network comprising circuitry configured to:
perform delay measurements with one or more nodes in the Segment Routing network on corresponding links to the one or more nodes,
utilize the delay measurements to determine delay-based availability of the corresponding links to the one or more nodes, wherein the delay-based availability describes how often a given link of the corresponding links is available in terms of quantum time intervals over a measurement interval, and
advertise details of the delay-based availability in the Segment Routing network for use as a delay-based availability metric for use as a traffic engineering (TE) metric.

2. The node of claim 1, wherein the circuitry is further configured to advertise details of the delay measurements for an average forward delay metric for use as another TE metric along with the delay-based availability metric.

3. The node of claim 1, wherein the delay-based availability is determined where the delay measurements are used to compare to a delay threshold for each quantum time interval to determine an available indicator and an unavailable indicator.

4. The node of claim 3, wherein the delay-based availability metric for a given measurement interval is based on [Available Indicator/(Available Indicator+Unavailable Indicator)].

5. The node of claim 1, wherein the delay-based availability is determined utilizing a loss-based availability algorithm defined in Metro Ethernet Forum (MEF) 10.3/35.1 where the delay measurements are used to compare to a delay threshold for each quantum time interval.

6. The node of claim 1, wherein the delay measurements utilize one of Two-Way Active Measurement Protocol (TWAMP) sessions and Simple Two-Way Active Measurement Protocol (STAMP).

7. The node of claim 1, wherein the details of the delay-based availability are advertised in a delay-based availability sub-Type-Length-Value (TLV).

8. The node of claim 1, wherein the details of the delay-based availability are advertised in a Flexible Algorithm Definition sub-Type-Length-Value (TLV).

9. The node of claim 1, wherein the circuitry is further configured to
receive advertisements of details of the delay-based availability for other links from other nodes in the Segment Routing network, and
utilize the delay-based availability for links in the Segment Routing network for TE path computation.

10. The node of claim 9, wherein the TE path computation selects a path in the Segment Routing network based on the delay-based availability and based on average forward delay metric, such that a path having highest delay-based availability is selected.

11. A method comprising steps of:
performing delay measurements with one or more nodes in a Segment Routing network on corresponding links to the one or more nodes;
utilizing the delay measurements to determine delay-based availability of the corresponding links to the one or more nodes, wherein the delay-based availability describes how often a given link of the corresponding links is available in terms of quantum time intervals over a measurement interval; and
advertising details of the delay-based availability in the Segment Routing network for use as a delay-based availability metric for use as a traffic engineering (TE) metric.

12. The method of claim 11, wherein the steps further include
advertising details of the delay measurements for an average forward delay metric for use as another TE metric along with the delay-based availability metric.

13. The method of claim 11, wherein the delay-based availability is determined where the delay measurements are used to compare to a delay threshold for each quantum time interval to determine an available indicator and an unavailable indicator.

14. The method of claim 13, wherein the delay-based availability metric for a given measurement interval is based on [Available Indicator/(Available Indicator+Unavailable Indicator)].

15. The method of claim 11, wherein the delay-based availability is determined utilizing a loss-based availability algorithm defined in Metro Ethernet Forum (MEF) 10.3/35.1 where the delay measurements are used to compare to a delay threshold for each quantum time interval.

16. The method of claim 11, wherein the delay measurements utilize one of Two-Way Active Measurement Protocol (TWAMP) sessions and Simple Two-Way Active Measurement Protocol (STAMP).

17. The method of claim 11, wherein the details of the delay-based availability are advertised in a delay-based availability sub-Type-Length-Value (TLV).

18. The method of claim 11, wherein the details of the delay-based availability are advertised in a Flexible Algorithm Definition sub-Type-Length-Value (TLV).

19. The method of claim 11, wherein the steps further include
receiving advertisements of details of the delay-based availability for other links from other nodes in the Segment Routing network; and
utilizing the delay-based availability for links in the Segment Routing network for TE path computation.

20. The method of claim 19, wherein the TE path computation selects a path in the Segment Routing network based on the delay-based availability and based on average forward delay metric, such that a path having highest delay-based availability is selected.
